(19) United States
(12) Patent Application Publication
(10) Pub. No.: US 2019/0057807 A1
(43) Pub. Date: Feb. 21, 2019

(54) ELECTROMAGNETIC INDUCTION DEVICE AND METHOD FOR MANUFACTURING SAME

(71) Applicant: BOLYMEDIA HOLDINGS CO. LTD., Santa Clara, CA (US)

(72) Inventor: Xiaoping HU, Shenzhen (CN)

(73) Assignee: Bolymedia Holdings Co. Ltd., Santa Clara, CA (US)

(21) Appl. No.: 16/078,361

(22) PCT Filed: Feb. 29, 2016
(86) PCT No.: PCT/CN2016/074864

§ 371 Date: Aug. 21, 2018

(51) Int. Cl. H01F 27/34; H01F 27/24; H01F 27/28; H01F 1/03; H01F 1/147; H01F 1/34; H01F 41/061

(52) U.S. Cl. CPC H01F 27/346; H01F 27/24; H01F 27/2804; H01F 41/061; H01F 1/14741; H01F 1/344; H01F 1/0315

(57) ABSTRACT

Disclosed are an electromagnetic induction device and a method for manufacturing the same. The device comprises a magnetic cover (110) and at least one set of coils (120). The magnetic cover (110) consists of two or more magnetic units (111), and a closed magnetic flux loop can be formed within each magnetic unit (111). The magnetic units (111) are joined together to form a substantially closed integrated body having at least one cavity (112) therein, and dividing surfaces between the magnetic units (111) are disposed substantially along the magnetic flux loop without interrupting the magnetic flux loop. The coils (120) are placed in the cavity (112) formed by the magnetic cover (110), electrodes of the coils (120) are led out of the magnetic cover (110), and the magnetic flux loop in the magnetic cover (110) is formed after energization of the coils (120). The electromagnetic induction device of the present invention can substantially close coils, preventing magnetic flux leakage to a maximum extent. Further, since dividing surfaces between magnetic units are disposed along a magnetic flux loop, no air gap is generated in the magnetic flux loop, thereby effectively decreasing magnetic resistance.

### TECHNICAL FIELD

The present disclosure relates to electronic or electric devices, and in particular, to electromagnetic induction devices and manufacturing methods thereof.

### BACKGROUND OF THE INVENTION

Generally, weak-current equipment (which operates in lower voltage and lower current) is referred to as an electronic device, while heavy-current equipment (which operates in higher voltage and higher current) is referred to as an electric device. Many electronic and electric devices, such as inductors, transformers and the like, operate based on electromagnetic induction effect.

An electromagnetic induction device may typically include a magnetic core and a coil. In an example shown in FIG. 1, a single-phase transformer has two sets of coils, i.e. a primary winding W1 and a secondary winding W2. When an alternating current is applied to electrodes at both ends of W1, an alternating magnetic field Φ is generated on a magnetic core wrapped by the winding. The magnetic field direction is in a right-handed spiral relationship with the current direction on W1. The alternating magnetic field produces an induced electromotive force on W2. W2 usually has a different numbers of coil turns than W1 to achieve voltage transformation. An inductor, regarded as a special case of a transformer whose output winding (i.e. the secondary winding) is open circuited, is also an electromagnetic induction device.

The structure of a conventional transformer is configured to wrap a magnetic core with coils. Such structure may lead to a large magnetic flux leakage for the transformer, causing energy loss and radiation damage. In order to reduce the magnetic flux leakage, there has been also a shell-type transformer in which the coils are wound by a portion of the magnetic core uncovered by the coils (i.e. magnetic yoke). As shown in FIG. 2, in an example shell-type transformer, two “E”-type magnets are usually adopted and fastened up and down to form a complete “EE”-type magnetic core i.e. a core stem at the center, the core stem is provided around with coils which are wrapped with outer magnetic yoke. However, the configuration of such transformer may still have some disadvantages in terms of magnetic flux leakage at both ends and increased magnetic resistance due to the presence of an air gap in a magnetic flux loop. Therefore, there is still a need to improve existing electromagnetic induction devices.

### SUMMARY OF THE INVENTION

According to one aspect of the present disclosure, an electromagnetic induction device is provided. The electromagnetic induction device may include a magnetic cover and at least one set of coils. The magnetic cover is consisted of two or more magnetic units, each magnetic unit is able to form a closed magnetic flux loop, and all of the magnetic units are fitted together to form a substantially closed integrated body having at least one cavity therein. A dividing surface between the magnetic units is arranged substantially along the magnetic flux loop without interrupting the magnetic flux loop. The coils is arranged in the cavity formed by the magnetic cover, the electrodes of the coils are led out of the magnetic cover, and the magnetic flux loop in the magnetic cover is produced after energization of the coils.

According to another aspect of the present disclosure, a method for manufacturing an electromagnetic induction device is provided. The method may include the steps of: determining a structure of the electromagnetic induction device according to the present disclosure, disintegrating the determined structure into a plurality of overlapped layers, and determining planar distribution for each layer, including distribution for magnetic material, distribution for conductive material, and distribution for insulation material, generating a magnetic material substrate, and generating layers one by one according to the determined planar distribution of each respective layer on the substrate.

With regard to the electromagnetic induction device according to the present disclosure, wrapping the coils by the magnetic cover composed of a plurality of magnetic units may, on the one hand, substantially enclose the coils, preventing magnetic flux leakage to a maximum extent, and on the other hand, since dividing surfaces between magnetic units are disposed along a magnetic flux loop, no air gap is generated in the magnetic flux loop, thereby effectively decreasing magnetic resistance. The manufacturing method according to the present disclosure may provide a method for manufacturing the electromagnetic induction device according to the present disclosure similar to the process of semiconductor integrated circuit, enabling large-scale fabrication of the electromagnetic induction device according to the present disclosure, and improving product efficiency and reducing product cost.

The embodiments of the present disclosure will be described in details in following with reference to the drawings.

### BRIEF DESCRIPTION OF THE DRAWINGS

FIG. 1 is a schematic view of the principle of a conventional single-phase transformer;

FIG. 2 is a schematic structural view of a conventional EE-type magnetic core;

FIG. 3 is a schematic structural view of an electromagnetic induction device according to a first embodiment;

FIG. 4 is a schematic structural view of an electromagnetic induction device according to a second embodiment;

FIG. 5 is a schematic structural view of an electromagnetic induction device according to a third embodiment;

FIG. 6 is a further sectional view showing a magnetic unit of the third embodiment.

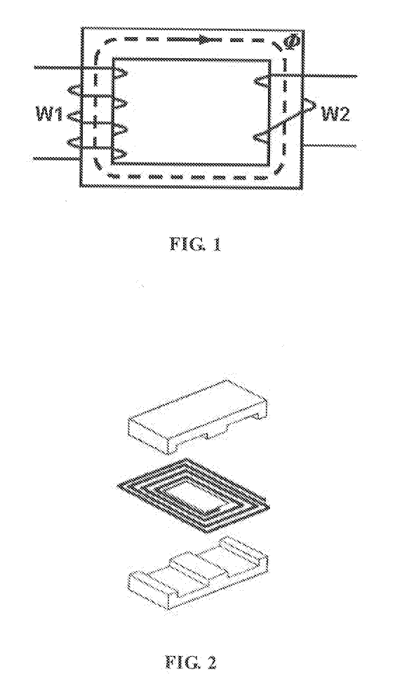

### DETAILED DESCRIPTION

An electromagnetic induction device in accordance with the present disclosure may include a magnetic cover and at least one set of coils.

The so-called magnetic cover refers to a magnetic material casing wrapped around the outside of the device and composed of two or more magnetic units, wherein all of the magnetic units fit together to form a substantially closed integrated body having at least one cavity therein. The so-called “substantially closed” means that the cavity is closed with respect to the exterior, except for one or more necessary channels (e.g. electrodes of the coils) communicating with the interior and exterior of the cavity, as well as one or more necessary apertures used for design or processing.

The coils are arranged in the cavity formed by the magnetic cover, and the electrodes of the coils are led out of the magnetic cover. A magnetic flux loop may be produced in the magnetic cover after energization of the coils. The coils may be configured to be one set so that the electromagnetic induction device is formed as an inductor, or the coils may be configured to be two or more sets such that the electromagnetic induction device is formed as an alternating current transformer with a single voltage output or a multiple-voltage output.

Each respective magnetic unit may be configured to be blocky, sheet, strip-shaped, or thin-film-shaped, etc.; and a closed magnetic flux loop can be produced within each respective magnetic unit. In other words, the coils may produce a magnetic flux loop on each magnetic unit with substantially no air gap. The so-called “substantially no air gap” means that the magnetic flux occupying a major portion of each respective magnetic unit is able to form a loop without an air gap. Where a small amount of magnetic flux fails to be closed in one magnetic unit due to difference in precision between theoretical design and actual product, process limitation and the like, it should not be considered beyond the scope of the present disclosure.

A dividing surface between the magnetic units is arranged substantially along the magnetic flux loop without interrupting the magnetic flux loop. According to the present disclosure, the magnetic unit or the dividing surface may be designed in the following manner: first, determining the structure of an integrated magnetic cover; next, determining the structure of a magnetic flux loop produced within the magnetic cover according to the arrangement of coils, such as winding configuration, placement mode of the coils in the cavity of the magnetic cover, and the like; then, providing dividing surfaces along the magnetic flux loop to divide the magnetic cover into a plurality of magnetic units, that is, dividing the entire magnetic flux loop into a plurality of mutually non-intersecting portions. The so-called “mutually non-intersecting” includes conditions that the portions are parallel to each other (i.e. portions having an identical path curvature) and that the portions are nesting with each other (i.e. portions with high path curvature are nested in portions with low path curvature).

Therefore, in a preferred embodiment, the dividing surfaces may include a plane dividing surface that divides the magnetic flux loop into two or more parallel portions, or a cylinder dividing surface that divides the magnetic flux loop into two or more portions nested with each other, or a combination thereof. For example, by means of first dividing a magnetic cover into blocks or pieces with plane dividing surfaces, then further dividing the blocks or pieces into layers with cylinder dividing surface, a magnetic cover having a configuration of parallel blocks and nested layers may be formed. The shape of the so-called cylinder dividing surface, which may be for example circular, elliptical, polygonal, or the like, may be determined based on the path curvature and the shape of the magnetic flux loop.

The division of the magnetic cover, especially dividing into multiple pieces or layers, or even dividing into multiple pieces or layers simultaneously, can effectively reduce eddy current, thereby decreasing energy consumption and operating temperature of the devices.

The magnetic cover or the magnetic units are made of magnetic materials and may be electrically conductive, preferably non-conductive. For example, the materials may be selected from a group consisting of: ferroferric oxide and mixtures thereof (e.g. cobalt-doped ferroferric oxide), chromium dioxide, ferric oxide and mixtures thereof, carbon-based ferromagnetic powder, resin carbon-based ferromagnetic powder, permalloy powder, Fe—Si—Al powder, Fe—Ni powder, ferrites, silicon steel, amorphous and nanocrystalline alloys, Fe-based amorphous alloys, iron-nickel base, Fe—Ni based-amorphous alloy, nanocrystalline alloy, supermalloy, and the like.

The coils may be made of a wire covered with an insulating layer, and the wire may be made of conductive material including copper, aluminum, magnesium, gold, silver, and an alloy material for conducting electricity.

In a preferred embodiment, a separator made of an insulating material may be arranged at the dividing surface, such as a spacer, a diaphragm, or an insulating varnish layer, to maintain separation of the magnetic units and reduce eddy current.

Specific applications of the electromagnetic induction device according to the present disclosure will be exemplified below, and the above description of the overall concept may be applied to the following embodiments.

### First Embodiment

FIG. 3 shows an embodiment of electromagnetic induction device in accordance with the present disclosure. The electromagnetic induction device may include a magnetic cover 110 and coils 120.

The cavity inside the magnetic cover is an annular one 112, and its overall shape may be doughnut-shaped, elliptical ring-shaped, rectangular, polygonal and the like. The normal section of the hollow portion of the cavity may be rectangular or round, or a relatively random shape as long as the coils can be wrapped therein. Preferably, the cavity should wrap the coils as closely as possible, and its shape can therefore substantially con form to the shape of the cross section of the coils.

In this embodiment, the magnetic cover is divided into two magnetic units having the same shape by a dividing surface substantially perpendicular to the center line of the annular cavity. For the convenience of demonstration, only one magnetic unit 111 is illustrated in FIG. 3, and therefore FIG. 3 also shows a cross-sectional structure of the magnetic cover along the dividing surface. The so-called the center line of the annular cavity may refer to a line composed of the centers of the normal section of the hollow portion of the cavity; accordingly, the extension direction of the center line is the extension direction of the annular cavity, and the shape of the center line may represent the overall shape of the cavity. It may not be convenient to determine a geometric center by the shape of the normal section of the cavity in view of actual situation, so the center line may be roughly determined based on the overall shape of the annular cavity, which should not be considered beyond the scope of the present disclosure.

The concept that the dividing surface is perpendicular to the center line means that the normal line of the dividing surface is coincided with the tangent line of the center line at the intersection of the dividing surface and the center line. For example, in this embodiment, the center line may form to be a circular ring, and the dividing surface is along the radial direction of the circular ring and perpendicular to a plane of the circular ring.

The coils 120 are formed by a wire winding around the wall of the annular cavity 112; and the wire extends in a direction substantially conforming to the extension direction of the annular cavity. In the figure, “x” may represent that current is flowed into the plane of the paper, “⊙” may represent current is flowed toward the viewer out of the plane of the paper, and the arrow on the dividing surface may represent the direction of the magnetic flux loop generated by the current. Obviously, the magnetic flux loop will not be cut off by dividing the magnetic cover along the dividing surface, thus the performance of the device may not be affected significantly. The coils may be configured to be a set of coils, or a plurality of sets of coils insulated from each other. In a preferred embodiment, the electrodes or leads of the coils may be drawn from the dividing surface to the outside of the magnetic cover (not shown).

In other embodiments, the magnetic cover may be divided into more magnetic units by a dividing surface which is substantially perpendicular to the center line of the annular cavity, as shown by the dashed lines in FIG. 3. Each of the magnetic units is an annular or tubular one having a hollow portion; and when all of the magnetic units fit together to be the magnetic cover, the hollow portions may be joined together to form an annular cavity having an end-to-end configuration.

Besides adopting the plane dividing surface that divides the magnetic flux loop into two or more parallel portions as described above, alternatively or additionally, in other embodiments, each magnetic unit may be divided into multiple layers sleeved one by one so as to further decrease eddy current. It is noted that the cylinder dividing surface used for dividing the nested magnetic units may need to be designed in accordance with the shape of the magnetic flux loop.

### Second Embodiment

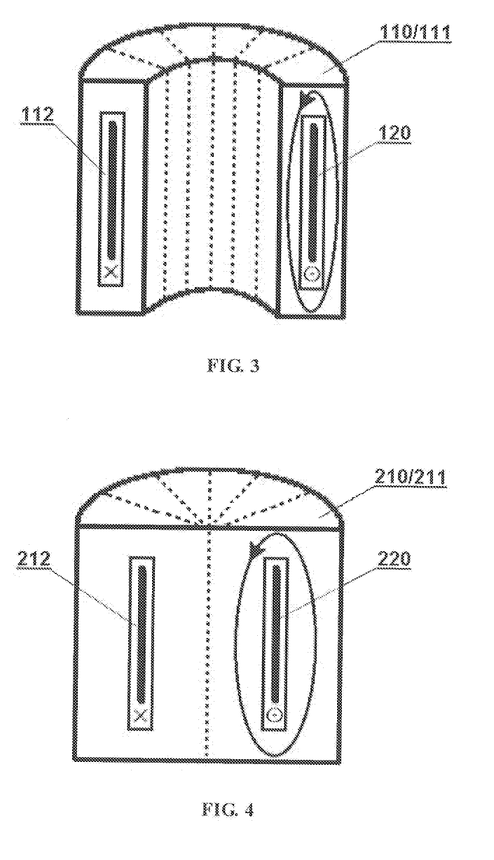

FIG. 4 shows another embodiment of electromagnetic induction device in accordance with the present disclosure. The electromagnetic induction device may include a magnetic cover 210 and coils 220.

The structure of this embodiment is similar to that of the first embodiment. The magnetic cover has an annular cavity 212 inside, and is divided into two magnetic units having the same shape by a dividing surface perpendicular to the center line of the annular cavity. For the convenience of demonstration, only one magnetic unit 211 is illustrated in FIG. 4. The difference between this embodiment and the first embodiment is that, the magnetic cover in the first embodiment is a hollow cylinder, while the magnetic cover in this embodiment is a solid (except for the annular cavity 212) cylinder. The division for the magnetic cover and the configuration of the coils can be referred to the first embodiment, which will not be repeated herein.

In other embodiments, the magnetic cover may be divided into more magnetic units by a dividing surface which is substantially perpendicular to the center line of the annular cavity, as shown by the dashed lines in FIG. 4. Further, the magnetic cover may also be alternatively or additionally divided into multiple layers sleeved one by one.

### Third Embodiment

FIG. 5 shows still another embodiment of electromagnetic induction device in accordance with the present disclosure. The electromagnetic induction device may include a magnetic cover 310 and coils 320.

The cavity inside the magnetic cover 310 is an annular cavity. The magnetic cover may be divided into two or more magnetic units by a dividing surface substantially parallel to the annulus of the annular cavity.

In this embodiment, the magnetic cover 310 is divided into four magnetic units, that is, a magnetic unit 311a as a top cap, a magnetic unit 311b (which may be a hollow cylinder or a solid cylinder) as the inner wall of the annular cavity, a magnetic unit 311c as the outer wall of the annular cavity, and a magnetic unit 311d as a bottom cap. The broken line in FIG. 5 represents the magnetic flux loop.

The coils 320 are formed by a wire winding around its axis, and the axis of the coils may be extended in a direction substantially conforming to the extension of the annular cavity. Since the magnetic field direction caused by the coils is coincided with the direction in which the axis is extended, no air gap is produced in the main magnetic flux loop by the dividing surface parallel to the annular surface.

In a preferred embodiment, this embodiment may further include an annular magnetic core 330 wrapped in the coils 320. The coils are wound around the magnetic core. Usage of the magnetic core can increase the magnetic field generated by the coils, helping to improve the effect of the device. The materials for making the magnetic core are similar to that for the magnetic cover. The magnetic cover and the magnetic core may be made of identical or different materials in one and the same device. It is obvious that the magnetic cover and the magnetic core are not connected to each other, the magnetic flux loops thereof are not intersected with each other, and the magnetic cover (also the magnetic units) and the magnetic core each carry a closed magnetic flux loop.

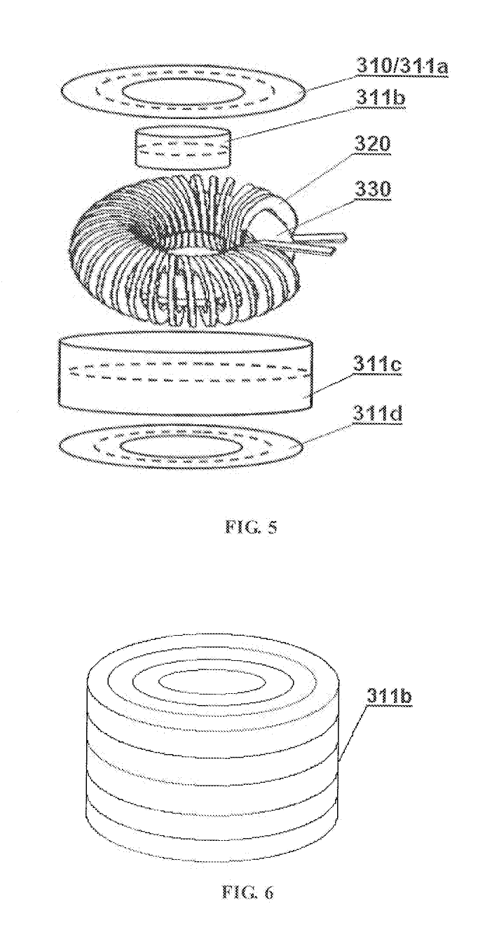

Similar to the foregoing embodiments, the magnetic cover may be further divided by the plane dividing surface into more magnetic units; alternatively or additionally, it may also be divided into nested layers by the cylinder dividing surface which is coaxial with the annulus of the annular cavity. For example, the magnetic unit 311b as the inner wall may be divided into a plurality of disks in a horizontal dividing manner, or it may also be divided into a plurality of cylinders sleeved one by one in an inside-to-outside dividing manner, or it may still also be divided by using both the horizontal dividing manner and inside-to-outside dividing manner into a plurality of doughnut-shaped strips which are configured to be mutually nested inside and outside and overlapped up and down, as shown in FIG. 6.

In a preferred embodiment, the magnetic core may also be divided in a manner similar to that by which the magnetic cover is divided so as to reduce eddy current. For example, the annular magnetic core 330 may be divided into two or more portions by a surface parallel to its annulus, and/or it may be divided into two or more portions by an annular surface coaxial therewith (referred to FIG. 6).

A method for manufacturing the electromagnetic induction device according to the present disclosure will now be described.

The electromagnetic induction device according to the present disclosure may be obtained by various manufacturing methods including the followings:

1. die casting for magnetic material powder: making coils (with or without magnetic core; the same applies hereinafter), properly protecting and wrapping the coils; putting the coils in a mold of a magnetic cover, placing insulating spacers at a surface designed as a dividing surface; filling magnetic material powder into the mold, and pressing it together with the coils as a whole, thus obtaining an electromagnetic induction device with a good closure property.

2. spraying for magnetic material powder: making coils, coating insulating glue onto the coils, spraying magnetic powder layer by layer onto the coils according to a designed dividing manner, and depositing an insulating film on the dividing surfaces between the layers, thus obtaining a multilayer magnetic cover having insulating layers.

The method for making coils may be a conventional winding one, or conductive coils may be made by using a flexible printed circuit board (FPCB), for example, a desire coil may be obtained by welding two ends of the FPCB.

In a preferred embodiment, the electromagnetic induction device according to the present disclosure may be manufactured by a processing method similar to that of a semiconductor integrated circuit, which may specifically include the following steps:

S1. determining a structure of the electromagnetic induction device according to the present disclosure intended to be made, such as the structures described in the various embodiments or similar embodiments described above. The shape of the device, the number of the coils, the number of winding turns, and the dividing manner for the magnetic cover may be designed in accordance with the needs of actual application.

S2. disintegrating the determined structure into a plurality of overlapped layers, and determining planar distribution for each layer, including distribution for magnetic material, distribution for conductive material, and distribution for insulation material. Such step is similar to the one in which the entire electromagnetic induction device is divided into pieces. For ease of manufacturing, when performing disintegrating into layers, it is preferred that the planar distribution of each layer may be achieved by a consistent process, such as coating, etching, and the like.

S3. generating a magnetic material substrate. Since the entire device is wrapped by the magnetic cover, the first layer should be a layer containing the magnetic cover, and it may therefore be manufactured from the magnetic material substrate.

S4. generating layers one by one according to the determined planar distribution of each respective layer on the substrate. The specific generating manner may be depended on actual needs and process capability, for example, it may include spraying, sputtering, coating, chemical precipitation, etc., and may refer to the processing of the semiconductor integrated circuit.

As an example, an instance for the above manufacturing method is: first making a magnetic substrate, then spraying or coating a coil-shaped insulating layer according to the coil configuration designed for the corresponding layer; spraying, sputtering or chemical precipitating a conductive layers on the coil-shaped insulating layer to form one or more coil-shaped conductive layer; covering and protecting the conductive layers with an insulating material, and spraying magnetic material so that the layer may have the same height as the coils and enclosing the coils; repeating the above process until the coils reach to a desired height and numbers of turns; and finally connecting all the conductive layers to be at least one conductive coil with an electrode leader stayed out, and the magnetic material forms a magnetic cover tightly wrapped around conductive coils.

This preferred manufacturing method has the same advantages as the processing for the semiconductor integrated circuit, by replicating each layer of the electromagnetic induction device to be processed, multiple devices can be processed simultaneously, thereby greatly improving production efficiency and reducing production costs.

The principle and embodiments of the present disclosure are described wither reference to the specific examples hereinabove. It should be understood that the embodiments above are merely used to facilitate understanding the present disclosure, but should not be interpreted as limitations to the present disclosure. For a person ordinarily skilled in the art, variations to the specific embodiments above may be made according to the concept of the present disclosure.

1. An electromagnetic induction device, comprising:
a magnetic cover consisting of two or more magnetic units, each magnetic unit being able to form a closed magnetic flux loop, all of the magnetic units fitting together to form a substantially closed integrated body having at least one cavity therein, and a dividing surface between the magnetic units being arranged substantially along the magnetic flux loop without interrupting the magnetic flux loop; and
at least one set of coils arranged in the cavity formed by the magnetic cover, the electrodes of the coils being led out of the magnetic cover, and the magnetic flux loop in the magnetic cover being produced after energization of the coils.

2. The electromagnetic induction device according to claim 1, wherein
the dividing surface comprises a plane dividing surface configured to divide the magnetic flux loop into two or more parallel portions, and/or a cylinder dividing surface configured to divide the magnetic flux loop into two or more portions nested with each other.

3. The electromagnetic induction device according to claim 1, wherein
the cavity inside the magnetic cover is an annular cavity, the magnetic cover is divided into two or more magnetic units by a dividing surface substantially perpendicular to the center line of the annular cavity; and
the coils are formed by a wire winding around the wall of the annular cavity, and the wire is extended in a direction substantially conforming to the extension direction of the annular cavity.

4. The electromagnetic induction device according to claim 3, wherein
the magnetic cover is also divided into nested magnetic units by a cylinder dividing surface surrounding the extension direction of the annular cavity.

5. The electromagnetic induction device according to claim 1, wherein
the cavity inside the magnetic cover is one annular cavity, the magnetic cover is divided into two or more magnetic units by a dividing surface substantially parallel to the annulus of the annular cavity; and
the coils are formed by a wire winding around its axis, and the axis of the coils is extended in a direction substantially conforming to the extension of the annular cavity.

6. The electromagnetic induction device according to claim 5, further comprising:
an annular magnetic core wrapped inside the coils.

7. The electromagnetic induction device according to claim 6, wherein
the annular magnetic core is divided into two or more portions by a surface parallel to its annulus, and/or the annular magnetic core may be divided into two or more portions by an annulus coaxial therewith.

8. The electromagnetic induction device according to claim 5, wherein:
the magnetic cover being further divided into nested magnetic units by a cylinder dividing surface which is coaxial with the annulus of the annular cavity.

9. The electromagnetic induction device according to claim 1, further comprising one or more of the following features:
the material used for making the magnetic units being selected from a group consisting of: ferroferric oxide and mixtures thereof, chromium dioxide, ferric oxide and mixtures thereof, carbon-based ferromagnetic powder, resin carbon-based ferromagnetic powder, permalloy powder, Fe—Si—Al powder, Fe—Ni powder, ferrites, silicon steel, amorphous and nanocrystalline alloys, Fe-based amorphous alloys, iron-nickel base, Fe—Ni based-amorphous alloy, nanocrystalline alloy, and supermalloy; and
a separator made of an insulating material and arranged at the dividing surface.

10. The electromagnetic induction device according to claim 1, wherein
the coils are configured to be one set so that the electromagnetic induction device is formed as an inductor, or
the coils are configured to be two or three or more sets such that the electromagnetic induction device is formed as an alternating current transformer with a single voltage output or a multiple-voltage output.

11. A method for manufacturing the electromagnetic induction device, comprising:
determining a structure of the electromagnetic induction device according to claim 1,
disintegrating the determined structure into a plurality of overlapped layers, and determining planar distribution for each layer, including distribution for magnetic material, distribution for conductive material, and distribution for insulation material,
generating a magnetic material substrate, and
generating layers one by one according to the determined planar distribution of each respective layer on the substrate.
